(19) United States
(12) Patent Application Publication
(10) Pub. No.: US 2012/0260876 A1
(43) Pub. Date: Oct. 18, 2012

(54) METHOD OF INCREASING FUEL EFFICIENCY

(75) Inventors: Anthony Cooney, Ellesmere Port (GB); Alan Ross, Ellesmere Port (GB); Vincent Burgess, Ellesmere Port (GB)

(73) Assignee: INNOSPEC LIMITED, Ellesmere Port, Cheshire (GB)

(21) Appl. No.: 13/375,321

(22) PCT Filed: Jun. 1, 2010
(86) PCT No.: PCT/GB2010/050921

§ 371 Date: Feb. 27, 2012

(30) Foreign Application Priority Data
Jun. 1, 2009 (GB) 0909351.9

(51) Int. Cl. F02B 47/04

(52) U.S. Cl. 123/1 A

(57) ABSTRACT

An additive, comprising a fatty acid and/or a derivative of a fatty acid and an amine, is used in a fuel for the purpose of increasing the efficiency of an engine combusting said fuel, in particular for the purpose of reducing the losses arising from the sliding of the pistons of an engine within their cylinders, and preferably with the result that fuel economy is improved.

The present invention relates to improvements in the operation of internal combustion engines and to associated improvements in fuel economy.

Over the years the price of fuel has undergone fluctuations, but the trend has been for it to become more expensive. This is to be expected fundamentally because of limitations in the supply, but also because of the taxation policy of Governments. The trend is expected to continue.

The present invention is concerned with additives which enable internal combustion engines too use fuel more efficiently; that is, with additives which increase the useful energy derived from an internal combustion engine and reduce the non-useful, or “lost”, energy.

There is a vast body of published information, patents and literature, concerning lubricants, and lubricating additives for fuel. However there is no causal relationship between the addition of a lubricating additive to a fuel, and the achievement of higher efficiency or greater useful output. For example a lubricating additive for fuel may be added in order to achieve lubrication, and hence maintain good operation, of a fuel pump, and not be directly associated with improvement in useful output.

A very widely used test to assess the lubricity of a fuel is the HFRR test. In the HFRR a wear scar is produced by a ball moved in reciprocation over the surface of an object, both immersed in a sample fuel. The size of the wear scar is taken as a measure of lubricity, and the test is very apt for situations in which one surface bears under load on another, and the aim is to assess wear.

The sliding of a plurality of pistons within their corresponding cylinders gives rise to a substantial energy loss when operating an engine.

It is an object of the present invention primarily to reduce the energy loss associated with the sliding pistons, on cylinder walls, within an engine.

In investigating this matter we found that certain additives gave excellent results in reducing such energy losses, as revealed by slide tests which reflected the sliding action of a piston within a cylinder. The performance shown was not revealed or predicted by HFRR testing.

In accordance with a first aspect of the present invention there is provided the use of an additive in a fuel for the purpose of increasing the efficiency of an engine combusting said fuel, wherein the additive comprises a fatty acid and/or a derivative of a fatty acid and an amine.

In accordance with a second aspect of the present invention there is provided the use of an additive in a fuel for the purpose of reducing the losses arising from the sliding of the pistons of an engine within their cylinders, wherein the additive comprises a fatty acid and/or a derivative of a fatty acid and an amine.

A derivative of a fatty acid and an amine herein may be a fatty acid amide or a salt of a fatty acid and an amine; or a mixture thereof may be used.

In some preferred embodiments, the additive composition comprises a fatty acid amide, and/or a salt of a fatty acid and an amine; preferably a fatty acid amide.

It is quite possible for an additive used in this invention to comprise a fatty acid, and a fatty acid amide, and a salt of a fatty acid and an amine. Such a composition may be achieved by mixing respective components but may be the result of treating a fatty acid with an amine under certain conditions.

In this specification when we talk about the amount or ratio of this additive we mean, when there is more than one of the said compounds, the summated amount.

Fatty acids such as tall oil fatty acids (TOFA) are materials commonly used as lubricity improvers, as are their esters, and amides, and the three classes are often presented alongside one another as readily available options. See for example U.S. Pat. No. 6,277,158 whose claims refer to “tall oil fatty acids or derivatives thereof”, and to EP 743974A which describes the acids and esters in equivalent terms.

However when we investigated fatty acids and derivatives thereof as efficiency promoters in engine tests, as distinct from wear reducing agents, we found, to our surprise, that whilst fatty acids themselves showed reasonable benefit, a commercial fatty acid ester did not. On the other hand a derivative of a fatty acid and an amine showed excellent benefit, to a level which could lead to worthwhile saving in fuel.

Thus, the incorporation of the additive of the invention, that is, the fatty acid or fatty acid amide obtained therefrom, or a mixture thereof, into fuel in an amount of the specific range improves the sliding action of the pistons in their cylinders and thereby improves the fuel economy.

We are aware of no prior disclosure suggesting that the fatty acid or fatty acid amide compounds defined herein would be expected to show stand-out levels of easing piston-on-cylinder sliding movement, to produce a worthwhile improvement in fuel economy.

The amount of the fuel additive of the invention is preferably up to 10,000 ppm in the fuel, preferably up to 1,000 ppm, preferably from 1 to 500 ppm, preferably 10 to 200 ppm, and preferably 15 to 100 ppm.

Preferably, the fatty acid is represented by the formula:

R(COOH)ₙ

wherein R represents a hydrocarbyl group having 2 to 50 carbon atoms, and n represents an integer of 1 to 4. For example, the fatty acid may be a monocarboxylic acid having 8 to 30 carbon atoms, such as oleic acid or tall oil fatty acid. Preferred fatty acids are those derived from vegetable oils and animal oils and fats.

In some preferred embodiments, mixtures of fatty acids are preferred; for example mixtures of fatty acids derived from vegetable oils and animal oils and fats.

Especially preferred fatty acids are tall oil fatty acids.

The preferred hydrocarbyl groups are aliphatic groups such as an alkyl group and an alkenyl group, which may have a straight chain or a branched chain. Examples of preferred fatty acids are aliphatic acids having 8 to 30 carbon atoms and include capric acid, lauric acid, myristic acid, stearic acid, isostearic acid, arachic acid, behenic acid, lignoceric acid, cerotic acid, montanic acid, melissic acid, caproleic acid, palmitic acid, oleic acid, eraidic acid, linolic acid, linoleic acid, fatty acid of coconut oil, fatty acid of hardened fish oil, fatty acid of hardened rapeseed oil, fatty acid of hardened tallow oil, soy fatty acid, and fatty acid of hardened palm oil. The examples further include dodecenyl succinic acid and its anhydride.

A fatty acid amide may be prepared by a dehydration-condensation reaction between a said fatty acid and an amine, for example at a temperature of 20 to 200° C. under atmospheric or reduced pressure.

A salt of a fatty acid and an amine can be obtained by mixing a said acid and the amine at a temperature of 20 to 100° C.

Preferred features of an amine which can be used for the formation of a salt or a amide are as follows.

Preferably the amine is an aliphatic amine, suitably having a hydrocarbyl group of 2 to 50 carbon atoms.

Preferably the amine has 1 to 10 nitrogen atoms.

Preferred amines are monoamines and diamines having a hydrocarbyl group of 8 to 20 carbon atoms. Their examples include coconut amine, capric amine, myristyl amine, stearyl amine, oleyl amine, tallow oil amine, stearyl propylene diamine, tallow oil diamine, oleyl propylene diamine, and amines derived from palm oil and rape seed oil. Also employable are polyamines having a hydrocarbyl group of 5 to 50 carbon atoms such as ethylenediamine, diethylenetriamine, triethylenetetramine, tetraethylenepentamine, and pentaethylene-hexamine.

In some preferred embodiments, preferred amines are polyamines and/or amines having additional hydroxyl functionality; for example ethanolamine and diethanolamine.

The ratio of amount of the aliphatic amine to the fatty acid in the amide additive of the invention may suitably be varied from 0.5 to 1.5 equivalents to one equivalent of the fatty acid. The additive may contain unreacted fatty acid or aliphatic amine within the range.

The additive of (1) the fatty acid, or a derivative of a fatty acid and an amine, namely (2A) a fatty acid amide or (2B) a salt of a fatty acid and an amine; or any mixture thereof, are incorporated into the selected fuel. Two or more such additives can be added to a fuel separately or in admixture. The additive can be previously diluted with a small amount of a diluent oil such as kerosene or an aromatic solvent to give a concentrated additive solution and the concentrated additive solution can be incorporated into the fuel to be treated. For instance, the fuel additive of the invention can be mixed with a diluent to give a concentrated additive solution containing 1 to 70 weight percent of the additive, and the thus obtained concentrated solution can then be diluted with the fuel to be treated.

Commercial fuels may include a number of additives which perform a variety of different functions. Depending on the fuel, additives may be used to improve engine performance, fuel handling, fuel stability and contaminant control. Typical additives include antioxidants to prevent oxidation and thus gum forming reactions; stability improvers to prevent sediment formation; metal deactivators to chelate to metal ions and prevent the catalysis thereby of oxidation reactions; cetane improvers to promote oxidation at higher temperatures by the generation of free radicals; octane improvers which prevent pre-ignition or knock in spark ignition engines; dispersants or detergents to prevent deposit formation in the injection system or remove existing deposits; valve seat recession additives; further lubricity improvers if wished, particularly to prevent wear; as well as corrosion inhibitors, anti-static additives, dehazers and demulsifiers, cold-flow improvers, anti-icing additives; pour-point improvers, CFPP improvers, wax anti-settling additives, anti-foams, dyes, markers, odour masks and drag reducers. For reasons of convenience and accurate dosing these are preferably provided in an additive composition with the said fatty acid or fatty acid amide of fatty acid amine salt but could if wished be added separately.

There are no specific limitations with respect to the fuel for which the invention is employable. The fuel may, for example, be diesel, gasoline, with or without oxygenates, including ethers and alcohols; or may itself be an alcohol, for example methanol or ethanol. Suitably the fuel is any fuel which may be used in compression ignition engines and spark ignition engines.

A gasoline fuel which may be used in the present invention is a liquid fuel for use with spark ignition engines (typically or preferably containing primarily or only C4-C12 hydrocarbons) and satisfying international gasoline specifications, such as ASTM D-439 and EN228. The term includes blends of distillate hydrocarbon fuels with oxygenated components such as ethanol, as well as the distillate fuels themselves.

A diesel fuel which may be used in the present invention may comprise a petroleum-based fuel oil, especially a middle distillate fuel oil. Such distillate fuel oils generally boil within the range of from 110° C. to 500° C., e.g. 150° C. to 400° C. The diesel fuel may comprise atmospheric distillate or vacuum distillate, cracked gas oil, or a blend in any proportion of straight run and refinery streams such as thermally and/or catalytically cracked and hydro-cracked distillates.

A diesel fuel which may be used in the present invention may comprise non-renewable Fischer-Tropsch fuels such as those described as GTL (gas-to-liquid) fuels, CTL (coal-to-liquid) fuels and OTL (oil sands-to-liquid).

A diesel fuel which may be used in the present invention may comprise a renewable fuel such as a biofuel or biodiesel.

A diesel fuel which may be used in the present invention may comprise 1st generation biodiesel. First generation biodiesel contains esters of, for example, vegetable oils, animal fats and used cooking fats. This form of biodiesel may be obtained by transesterification of oils, for example rapeseed oil, soybean oil, safflower oil, palm 25 oil, corn oil, peanut oil, cotton seed oil, tallow, coconut oil, physic nut oil (Jatropha), sunflower seed oil, used cooking oils, hydrogenated vegetable oils or any mixture thereof, with an alcohol, usually a monoalcohol, in the presence of a catalyst.

A diesel fuel which may be used in the present invention may comprise second generation biodiesel. Second generation biodiesel is derived from renewable resources such as vegetable oils and animal fats and processed, often in the refinery, often using hydroprocessing such as the H-Bio process developed by Petrobras. Second generation biodiesel may be similar in properties and quality to petroleum based fuel oil streams, for example renewable diesel produced from vegetable oils, animal fats etc. and marketed by ConocoPhillips as Renewable Diesel and by Neste as NExBTL.

A diesel fuel which may be used in the present invention may comprise third generation biodiesel. Third generation biodiesel utilises gasification and Fischer-Tropsch technology including those described as BTL (biomass-to-liquid) fuels. Third generation biodiesel does not differ widely from some second generation biodiesel, but aims to exploit the whole plant (biomass) and thereby widens the feedstock base.

A diesel fuel which may be used in the present invention may contain blends of any or all of the above diesel fuels.

In some embodiments a diesel fuel which may be used in the present invention may be a blended diesel fuel comprising bio-diesel. In such blends the bio-diesel may be present in an amount of, for example up to 0.5%, up to 1%, up to 2%, up to 3%, up to 4%, up to 5%, up to 10%, up to 20%, up to 30%, up to 40%, up to 50%, up to 60%, up to 70%, up to 80%, up to 90%, up to 95% or up to 99%.

In some embodiments a diesel fuel which may be used in the present invention may comprise a secondary fuel, for example ethanol and/or an alcohol and/or ether as an oxygenate. Preferably however the diesel fuel does not contain ethanol.

Preferably, a diesel fuel which may be used in the present invention has a sulphur content of at most 0.05% by weight, more preferably of at most 0.035% by weight, especially of at most 0.015%. Fuels with even lower levels of sulphur are also suitable such as, fuels with less than 50 ppm sulphur by weight, preferably less than 20 ppm, for example 10 ppm or less.

Examples of diesel fuels to which the invention is applicable are diesel fuels which have been treated to reduce the sulphur content to have the above content. Preferred diesel fuels are those which are as defined in BS EN 590 or ASTM D975

In addition to the additive mentioned above, which is a fatty acid and/or amine derivative of a fatty acid, the use of the invention may include one or more additional friction modifiers, that is, one or more additional friction modifiers which are not fatty acids or amine derivatives of fatty acids. Such additional friction modifiers are called hereinafter AFMs for brevity and clarity.

AFMs known in the art include the following:
Esters of fatty acids
Aliphatic amines
Aliphatic esters
Aromatic esters
Aliphatic ethers
Polyethers
Polyetheramines
Polyhydric aliphatic alcohols
Hydrocarbyl succinic acids and derivatives
Reaction products of acylating agents and amines, for example poly(isobutenylsuccinimides) (PIBSIs)
N,N-bis(hydroxyalkyl)-alkylamine
Hydroxyl containing esters of mono carboxylic acid and polyols
Alkylalkoxy amides
Polyalkylene amines
Mannich bases based on tertiary alky substituted phenol and C1-20 primary amines or polyalkylene amines
Polyisobutylene amines
Mixtures of esters (e.g. as defined herein) and polyisobutylene amines
Mixtures of esters (e.g. as defined herein) and polyetheramines.

Examples of sources of information about AFMs which are believed to be of use in the present invention are as follows. Any of these may be regarded as a preferred feature of the present invention and so may be claimed, in conjunction with any of the first, second and third aspects given above. The patent specifications mentioned may be consulted if more information is required.

U.S. Pat. No. 4,396,517: the AFMs in this disclosure of interest in the present invention are Mannich bases based on C4-20 tertiary alkyl substituted phenol, aldehyde and C1-20 primary amines. An example includes the di(mono-cocoamine) mannich base of p-tert-butylphenol, paraformaldehyde and cocoamine.
the phenol may suitably be of the formula

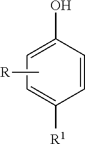

wherein R is preferably hydrogen, but can be a C1 to C30 hydrocarbyl group, which may be an alkyl, alkenyl, aryl, alkaryl or aralkyl group and R¹ is preferably a tertiary hydrocarbyl group, preferably alkyl or alkenyl containing 4 to 20 carbon atoms. Representative phenols that may be used are p-tert-butylphenols, p-tert-octylphenol, p-tert-dodecyl-phenol, p-tert-hexadecylphenol.
the aldehyde contemplated may be an aliphatic aldehydes, typified by formaldehyde or paraformaldehyde, acetaldehyde, and aldol (beta-hydroxy butyraldehyde); aromatic aldehydes, such as benzaldehyde and heterocyclic aldehydes, such as furfural. The aldehyde may contain a substituent group such as hydroxyl, halogen, nitro and the like. In short, any substituent can be used which does not take a major part in the reaction. Preference, however, is given to the aliphatic aldehydes, formaldehyde being particularly preferred.
the amine may contain a primary amino group. Preferably, these include saturated and unsaturated aliphatic amines containing 1 to 20 carbon atoms, for example polyalkylenepolyamines of the formula NHₙ(R²NH)ₙH.

U.S. Pat. No. 4,427,562: the AFMs in this disclosure of interest in the present invention are N-alkoxyalkyl amides represented by the following formula:

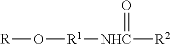

wherein R is a hydrocarbyl group or a mixture of hydrocarbyl groups containing from about 5-30 carbon atoms; R¹ is a hydrocarbyl group containing from about 2-10 carbon atoms; and R² is hydrogen. The N-alkoxyalkyl amides may be formed by the reaction of primary alkoxyalkylamines with carboxylic acids such as formic acid, or alternatively by ammonolysis of the appropriate formate ester.

U.S. Pat. No. 4,617,026: the AFMs in this disclosure of interest in the present invention are hydroxyl-containing esters of a monocarboxylic acid and a glycol or trihydric alcohol, said ester additive having at least one free hydroxyl group. More particularly, the AFM may be an ester of a monocarboxylic acid and a glycol or trihydric alcohol, said acid having about 12 to about 30 carbon atoms, said glycol being an alkane diol or oxa-alkane diol wherein said alkane is a straight chain hydrocarbon of about 2 to about 5 carbon atoms and said trihydric alcohol has a straight chain hydrocarbon structure of about 3 to about 6 carbon atoms, said ester additive having at least one free hydroxyl group. Examples include glycerol monooleate and glycerol dioleate.

WO9835000: the AFMs in this disclosure of interest in the present invention are C7+ primary, linear alcohols, preferably C12-C24. The alcohol may be added in an amount of at least about 0.05 to 0.5 wt % fuel.

U.S. Pat. No. 6,203,584: the AFMs in this disclosure of interest in the present invention are (1) a fuel-soluble aliphatic hydrocarbyl-substituted amine having at least one basic nitrogen atom where the hydrocarbyl group has a number average molecular weight of about 700 to 3,000, and (2) a poly(oxyalkylene)amine having at least one basic nitrogen atom and a sufficient number of oxyalkylene units to render the poly(oxyalkylene)amine soluble in hydrocarbons boiling in the gasoline range; and (b) an ester of a carboxylic acid and a polyhydric alcohol, wherein the carboxylic acid has from one to about four carboxylic acid groups and from about 8 to about 50 carbon atoms and the polyhydric alcohol has from about 2 to about 50 carbon atoms and from about 2 to about 6 hydroxy groups.

Examples comprise combinations of pibamine or polyetheramine with glycerol monooleate or pentaerythritol mono oleate

WO 01/72930: the AFMs in this disclosure of interest in the present invention are the reaction products of a natural or synthetic oil, for example a C6-C22 fatty acid ester, for example an oil is selected from the group consisting of beef tallow oil, lard oil, palm oil, castor oil, cottonseed oil, corn oil, peanut oil, soybean oil, sunflower oil, olive oil, whale oil, menhaden oil, sardine oil, coconut oil, palm kernel oil, babassu oil, rape oil and soya oil: and at least one alkanolamine preferably selected from the group consisting of monoethanolamine, diethanolamine, propanolamine, isopropanolamine, dipropanolamine, di-isopropanolamine, butanolamines, aminoethylaminoethanol and mixtures thereof. For example the reaction product of coconut oil and diethanolamine.

US2004/0154218: the AFMs in this disclosure of interest in the present invention include polyalkylene oxides, preferably derived from an alkylene oxide wherein the alkylene group has from about 2 to 5 carbon atoms. Preferably, the polyalkylene-oxide is an oligomer or polymer of an alkylene oxide selected from the group consisting of ethylene oxide, propylene oxide, butylene oxide, and pentylene oxide. Ethylene oxide and propylene oxide are particularly preferred. In addition, mixtures of alkylene oxides are desirable in which, for example, a mixture of ethylene oxide and propylene oxide may be used. A respective molar ratio of from about 1:5 to 5:1 may be used in the case of a mixture of ethylene oxide and propylene oxide. The polyalkylene-oxide may also be end-capped with an ether or ester function to give, for example, a mono-alkoxy polyalkylene-oxide, such as n-butoxy polypropylene glycol. A desirable number of moles of the polyalkylene-oxide will be in the range of from about 3 to 50 moles of alkylene oxide per 1 mole of hydrocarbyl amide. More preferably, the range of from about 3 to 20 moles is particularly desirable. Most preferably, the range of from about 4 to 15 moles is most preferable.

EP0020037: the AFMs in this disclosure of interest in the present invention are oil-soluble aliphatic hydrocarbyl-substituted succinimide or succinamide materials, wherein the hydrocarbyl group contains about 12 to 36 carbon atoms and is preferably derived from an isomerized straight chain alpha-olefin.

Alternatively: we may define suitable and related AFMs as being the reaction product of a carboxylic acid-derived acylating agent and an amine; for example PIBSA, suitably having a hydrocarbyl substituent with a number average molecular weight (Mn) of between 250 to 1500, a polyalkylene polyamine, preferably with 1 to 6 carbon atoms and preferably with 2 to 8 nitrogen atoms, for example ethylenediamine, diethylenetriamine, triethylenetetramine, tetraethylenepentamine, tri(tri-methylene)tetramine, pentaethylenehexamine, aminoethylethanolamine, hexaethyleneheptamine or 1,2-propylenediamine. Preferably the molar ratio of acylating agent:amino compound is preferably from 2:1 to 1:1.

Alternatively: a number of suitable acylated, nitrogen-containing compounds having a hydrocarbyl substituent of at least 8 carbon atoms and made by reacting a carboxylic acid acylating agent with an amino compound are known to those skilled in the art. In such compositions the acylating agent is linked to the amino compound through an imido, amido, amidine or acyloxy ammonium linkage. The hydrocarbyl substituent of at least 8 carbon atoms may be in either the carboxylic acid acylating agent derived portion of the molecule or in the amino compound derived portion of the molecule, or both. Preferably, however, it is in the acylating agent portion. The acylating agent can vary from formic acid and its acylating derivatives to acylating agents having high molecular weight aliphatic substituents of up to 5,000, 10,000 or 20,000 carbon atoms. The amino compounds can vary from ammonia itself to amines typically having aliphatic substituents of up to about 30 carbon atoms, and up to 11 nitrogen atoms.

A preferred class of acylated amino compounds suitable for use in the present invention are those formed by the reaction of an acylating agent having a hydrocarbyl substituent of at least 8 carbon atoms and a compound comprising at least one primary or secondary amine group. The acylating agent may be a mono- or polycarboxylic acid (or reactive equivalent thereof) for example a substituted succinic, phthalic or propionic acid and the amino compound may be a polyamine or a mixture of polyamines, for example a mixture of ethylene polyamines. Alternatively the amine may be a hydroxyalkyl-substituted polyamine. The hydrocarbyl substituent in such acylating agents preferably comprises at least 10, more preferably at least 12, for example 30 or 50 carbon atoms. It may comprise up to about 200 carbon atoms. Preferably the hydrocarbyl substituent of the acylating agent has a number average molecular weight (Mn) of from 160 to 5000, preferably from 170 to 2800, for example from 250 to 1500, preferably from 500 to 1500 and more preferably 500 to 1100. An Mn of 700 to 1300 is especially preferred. In a particularly preferred embodiment, the hydrocarbyl substituent has a number average molecular weight of 700-1000.

Illustrative of hydrocarbyl substituent based groups containing at least eight carbon atoms are n-octyl, n-decyl, n-dodecyl, tetrapropenyl, n-octadecyl, oleyl, chloroctadecyl, triicontanyl, etc. The hydrocarbyl based substituents may be made from homo- or interpolymers (e.g. copolymers, terpolymers) of mono- and di-olefins having 2 to 10 carbon atoms, for example ethylene, propylene, butane-1, isobutene, butadiene, isoprene, 1-hexene, 1-octene, etc. Preferably these olefins are 1-monoolefins. The hydrocarbyl substituent may also be derived from the halogenated (e.g. chlorinated or brominated) analogs of such homo- or interpolymers. Alternatively the substituent may be made from other sources, for example monomeric high molecular weight alkenes (e.g. 1-tetra-contene) and chlorinated analogs and hydrochlorinated analogs thereof, aliphatic petroleum fractions, for example paraffin waxes and cracked and chlorinated analogs and hydrochlorinated analogs thereof, white oils, synthetic alkenes for example produced by the Ziegler-Natta process (e.g. poly(ethylene) greases) and other sources known to those skilled in the art. Any unsaturation in the substituent may if desired be reduced or eliminated by hydrogenation according to procedures known in the art.

The term “hydrocarbyl” as used within this specification denotes a group having a carbon atom directly attached to the remainder of the molecule and having a predominantly aliphatic hydrocarbon character. Suitable hydrocarbyl based groups may contain non-hydrocarbon moieties. For example they may contain up to one non-hydrocarbyl group for every ten carbon atoms provided this non-hydrocarbyl group does not significantly alter the predominantly hydrocarbon character of the group. Those skilled in the art will be aware of such groups, which include for example hydroxyl, halo (especially chloro and fluoro), alkoxyl, alkyl mercapto, alkyl sulphoxy, etc. Preferred hydrocarbyl based substituents are purely aliphatic hydrocarbon in character and do not contain such groups.

The hydrocarbyl-based substituents are preferably predominantly saturated, that is, they contain no more than one carbon-to-carbon unsaturated bond for every ten carbon-to-carbon single bonds present. Most preferably they contain no more than one carbon-to-carbon non-aromatic unsaturated bond for every 50 carbon-to-carbon bonds present.

Preferred hydrocarbyl-based substituents are poly-(isobutene)s known in the art.

Conventional polyisobutenes and so-called “highly-reactive” polyisobutenes are suitable for use in the invention. Highly reactive polyisobutenes in this context are defined as polyisobutenes wherein at least 50%, preferably 70% or more, of the terminal olefinic double bonds are of the vinylidene type as described in EP0565285. Particularly preferred polyisobutenes are those having more than 80 mol % and up to 100 mol % of terminal vinylidene groups such as those described in EP1344785.

Amino compounds useful for reaction with these acylating agents include the following:

(1) polyalkylene polyamines of the general formula:

(R³)₂N[U—N(R³)]ₙR³

wherein each R³ is independently selected from a hydrogen atom, a hydrocarbyl group or a hydroxy-substituted hydrocarbyl group containing up to about 30 carbon atoms, with proviso that at least one R³ is a hydrogen atom, n is a whole number from 1 to 10 and U is a C1-18 alkylene group. Preferably each R³ is independently selected from hydrogen, methyl, ethyl, propyl, isopropyl, butyl and isomers thereof. Most preferably each R³ is ethyl or hydrogen. U is preferably a C1-4 alkylene group, most preferably ethylene.

Specific examples of polyalkylene polyamines (1) include ethylenediamine, diethylenetriamine, triethylenetetramine, tetraethylenepentamine, tri(tri-methylene)tetramine, pentaethylenehexamine, hexaethylene-heptamine, 1,2-propylenediamine, and other commercially available materials which comprise complex mixtures of polyamines. For example, higher ethylene polyamines optionally containing all or some of the above in addition to higher boiling fractions containing 8 or more nitrogen atoms etc.

Specific examples of polyalkylene polyamines (1) which are hydroxyalkyl-substituted polyamines include N-(2-hydroxyethyl)ethylene diamine, N,N′-bis(2-hydroxyethyl)ethylene diamine, N-(3-hydroxybutyl)tetramethylene diamine, etc.

(2) heterocyclic-substituted polyamines including hydroxyalkyl-substituted polyamines wherein the polyamines are as described above and the heterocyclic substituent is selected from nitrogen-containing aliphatic and aromatic heterocycles, for example piperazines, imidazolines, pyrimidines, morpholines, etc.

Specific examples of the heterocyclic-substituted polyamines (2) are N-2-aminoethyl piperazine, N-2 and N-3 amino propyl morpholine, N-3(dimethyl amino) propyl piperazine, 2-heptyl-3-(2-aminopropyl) imidazoline, 1,4-bis(2-aminoethyl)piperazine, 1-(2-hydroxy ethyl)piperazine, and 2-heptadecyl-1-(2-hydroxyethyl)-imidazoline, etc.

(3) aromatic polyamines of the general formula:

Ar(NR³₂)_{y}

wherein Ar is an aromatic nucleus of 6 to 20 carbon atoms, each R³ is as defined above and y is from 2 to 8.

Specific examples of the aromatic polyamines (3) are the various isomeric phenylene diamines, the various isomeric naphthalene diamines, etc.

4) The amine reactant may alternatively be a compound of general formula R²R³NH where each of R² and R³ independent represents a hydrocarbyl group (as defined herein), preferably a hydrocarbon group (as defined herein), or a hydrogen atom.

Preferably at least one of R² and R³ represents a hydrocarbyl group.

Preferably both R² and R³ represent a hydrocarbyl group.

Suitable terminal groups of a hydrocarbyl group R² and/or R³ may include —CH₃, ═CH₂, —OH, —C(O)OH and derivatives thereof. Suitable derivatives include esters and ethers. Preferably a hydrocarbyl group R² and/or R³ does not contain a terminal amine.

A preferred hydrocarbyl group for each of R² and R³ is a group of the formula

—[R⁴NH]ₚR⁵X

wherein R⁴ is an alkylene group having from 1 to 10 carbons, preferably from 1 to 5, preferably 1 to 3 carbons, preferably 2 carbons;
wherein R⁵ is an alkylene group having from 1 to 10 carbons, preferably from 1 to 5, preferably 1 to 3 carbons, preferably 2 carbons;
wherein p is an integer from 0 to 10;
wherein X is selected from —CH₃, —CH₂═CH₂, —OH, and —C(O)OH.

A preferred hydrocarbyl group for each of R² and R³ is a group of the formula

—[(CH₂)_{q}NH]ₚ(CH₂)ᵣX

wherein p is an integer from 0 to 10, preferably 1 to 10, preferably from 1 to 5, preferably from 1 to 3, preferably 1 or 2;
wherein q is an integer from 1 to 10, preferably 1 to 10, preferably from 1 to 5, preferably from 1 to 3, preferably 1 or 2;
wherein r is an integer from 1 to 10, preferably 1 to 10, preferably from 1 to 5, preferably from 1 to 3, preferably 1 or 2; and
wherein X is selected from —CH₃, —CH₂═CH₂, —OH, and —C(O)OH.

Preferably X is —CH₃, or —OH.

Further amines which may be used in this invention include compounds derived from amines selected from ammonia, butylamine, aminoethylethanolamine, aminopropan-2-ol, 5-aminopentan-1-ol, 2-(2-aminoethoxy)ethanol, monoethanolamine, 3-aminopropan-1-ol, 2-((3-aminopropyl)amino)ethanol, dimethylaminopropylamine, and N-(alkoxyalkyl)-alkanediamines including N-(octyloxyethyl)-1,2-diaminoethane and N-(decyloxypropyl)-N-methyl-1,3-diaminopropane.

Specific examples of amines which may be used in this invention and having a tertiary amino group can include but are not limited to: N,N-dimethyl-aminopropylamine, N,N-diethyl-aminopropylamine, N,N-dimethyl-amino ethylamine. The nitrogen or oxygen containing compounds capable of condensing with the acylating agent and further having a tertiary amino group can further include amino alkyl substituted heterocyclic compounds such as 1-(3-aminopropyl)imidazole and 4-(3-aminopropyl)morpholine, 1-(2-aminoethyl)piperidine, 3,3-diamino-N-methyldi-propylamine, and 3′3-aminobis(N,N-dimethylpropylamine). Other types of compounds capable of condensing with the acylating agent and having a tertiary amino group include alkanolamines including but not limited to triethanolamine, trimethanolamine, N,N-dimethylaminopropanol, N,N-diethylaminopropanol, N,N-diethylaminobutanol, N,N,N-tris(hydroxyethyl)amine and N,N,N-tris(hydroxymethyl)amine.

Many patents have described useful acylated nitrogen compounds including U.S. Pat. Nos. 3,172,892; 3,219,666; 3,272,746; 3,310,492; 3,341,542; 3,444,170; 3,455,831; 3,455,832; 3,576,743; 3,630,904; 3,632,511; 3,804,763, 4,234,435 and U.S. Pat. No. 6,821,307.

A preferred acylated nitrogen-containing compound of this class is that made by reacting a poly(isobutene)-substituted succinic acid-derived acylating agent (e.g., anhydride, acid, ester, etc.) wherein the poly(isobutene) substituent has between about 12 to about 200 carbon atoms and the acylating agent has from 1 to 5, preferably from 1 to 3, preferably 1 or 2, succinic-derived acylating groups; with a mixture of ethylene polyamines having 3 to about 9 amino nitrogen atoms, preferably about 3 to about 8 nitrogen atoms, per ethylene polyamine and about 1 to about 8 ethylene groups. These acylated nitrogen compounds are formed by the reaction of a molar ratio of acylating agent:amino compound of from 10:1 to 1:10, preferably from 5:1 to 1:5, more preferably from 2:1 to 1:2 and most preferably from 2:1 to 1:1. In especially preferred embodiments, the acylated nitrogen compounds are formed by the reaction of acylating agent to amino compound in a molar ratio of from 1.8:1 to 1:1.2, preferably from 1.6:1 to 1:1.2, more preferably from 1.4:1 to 1:1.1 and most preferably from 1.2:1 to 1:1. This type of acylated amino compound and the preparation thereof is well known to those skilled in the art and are described in the above-referenced US patents.

Another type of acylated nitrogen compound belonging to this class is that made by reacting the afore-described alkylene amines with the afore-described substituted succinic acids or anhydrides and aliphatic mono-carboxylic acids having from 2 to about 22 carbon atoms. In these types of acylated nitrogen compounds, the mole ratio of succinic acid to mono-carboxylic acid ranges from about 1:0.1 to about 1:1. Typical of the monocarboxylic acid are formic acid, acetic acid, dodecanoic acid, butanoic acid, oleic acid, stearic acid, the commercial mixture of stearic acid isomers known as isostearic acid, tolyl acid, etc. Such materials are more fully described in U.S. Pat. Nos. 3,216,936 and 3,250,715.

A further type of acylated nitrogen compound suitable for use in the present invention is the product of the reaction of a fatty monocarboxylic acid of about 12-30 carbon atoms and the afore-described alkylene amines, typically, ethylene, propylene or trimethylene polyamines containing 2 to 8 amino groups and mixtures thereof. The fatty mono-carboxylic acids are generally mixtures of straight and branched chain fatty carboxylic acids containing 12-30 carbon atoms. Fatty dicarboxylic acids could also be used. A widely used type of acylated nitrogen compound is made by reacting the afore-described alkylene polyamines with a mixture of fatty acids having from 5 to about 30 mole percent straight chain acid and about 70 to about 95 percent mole branched chain fatty acids. Among the commercially available mixtures are those known widely in the trade as isostearic acid. These mixtures are produced as a by-product from the dimerization of unsaturated fatty acids as described in U.S. Pat. Nos. 2,812,342 and 3,260,671.

The branched chain fatty acids can also include those in which the branch may not be alkyl in nature, for example phenyl and cyclohexyl stearic acid and the chloro-stearic acids. Branched chain fatty carboxylic acid/alkylene polyamine products have been described extensively in the art. See for example, U.S. Pat. Nos. 3,110,673; 3,251,853; 3,326,801; 3,337,459; 3,405,064; 3,429,674; 3,468,639; 3,857,791. These patents are referenced for their disclosure of fatty acid/polyamine condensates for their use in lubricating oil formulations.

Suitably the molar ratio of the acylating group of an acylating agent defined above and the reacting amine group of said amine is in the range 0.5-5:1, preferably 0.8-2.2:1. At a ratio of 1:1 the reaction product is called mono-PIBSI, and at a ratio of 2:1 it is called bis-PIBSI and requires a polyamine as reactant.

US2005/223630: the AFMs in this disclosure of interest in the present invention are the reaction products of a carboxylic acid-derived acylating agent and an amine; for example a polyisobutenyl succinimide. An alternative or additional AFMs in or based on this disclosure of interest in the present invention may be one or more additional components selected from:
a) carrier oils comprising an optionally esterified polyether,
b) polyetheramines,
c) hydrocarbyl-substituted amines wherein the hydrocarbyl substituent is substantially aliphatic and contains at least 8 carbon atoms,
d) nitrogen-containing condensates of a phenol, aldehyde and primary or secondary amine,
e) aromatic esters of a polyalkylphenoxyalkanol.

Compounds a) to e) may be described further as follows:

a) Carrier Oil

A carrier oil may have any suitable molecular weight. A preferred molecular weight is in the range 500 to 5000.

In a preferred aspect the polyether carrier oil is a mono end-capped polypropylene glycol. Preferably the end cap is a group consisting of or containing a hydrocarbyl group having up to 30 carbon atoms. More preferably the end cap is or comprises an alkyl group having from 4 to 20 carbon atoms or from 12 to 18 carbon atoms.

The alkyl group may be branched or straight chain. Preferably it is a straight chain group.

Further hydrocarbyl end capping groups include alkyl-substituted phenyl, especially where the alkyl substituent(s) is or are alkyl groups of 4 to 20 carbon atoms, preferably 8 to 12, preferably straight chain.

The hydrocarbyl end capping group may be attached to the polyether via a linker group. Suitable end cap linker groups include an ether oxygen atom (—O—), an amine group (—NH—), an amide group (—CONH—), or a carbonyl group —(C═O)—.

In a preferred embodiment the carrier oil is a polypropyleneglycol monoether of the formula:

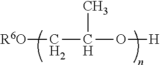

where R⁶ is straight chain C₁-C₃₀ alkyl, preferably C₄-C₂₀ alkyl, preferably C₁₂-C₁₈ alkyl; and n is an integer of from 10 to 50, preferably 10 to 30, more preferably 12 to 20.

Such alkyl polypropyleneglycol monoethers are obtainable by the polymerisation of propylene oxide using an aliphatic alcohol, preferably a straight chain primary alcohol of to 20 carbon atoms, as an initiator. If desired a proportion of the propyleneoxy units may be replaced by units derived from other C₂-C₆ alkylene oxides, e.g. ethylene oxide or isobutylene oxide, and are to be included within the term “polypropyleneglycol”. The initiator may also be a phenol or alkyl phenol of the formula R⁷OH, a hydrocarbyl amine or amide of the formula R⁷NH₂ or R⁷CONH, respectively, where R⁷ is C₁-C₃₀ hydrocarbyl group, preferably a saturated aliphatic or aromatic hydrocarbyl group such as alkyl, phenyl or phenalkyl etc. Preferred initiators include long chain alkanols giving rise to the long chain polypropyleneglycol monoalkyl ethers.

In a further aspect the polypropyleneglycol may be an ester (R⁶COO) group where R⁶ is defined above. In this aspect the carrier oil may be a polypropyleneglycol monoester of the formula

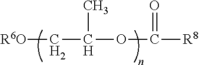

where R⁶ and n are as defined above and R⁸ is a C₁-C₃₀ hydrocarbyl group, preferably an aliphatic hydrocarbyl group, and more preferably C₁-C₁₀ alkyl.

b) Polyetheramines

Suitable hydrocarbyl-substituted polyoxyalkylene amines or polyetheramines are described in the literature (for example U.S. Pat. No. 6,217,624 and U.S. Pat. No. 4,288,612) and have the general formula:

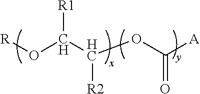

or a fuel-soluble salt thereof; wherein R is a hydrocarbyl group having from about 1 to about 30 carbon atoms; R1 and R2 are each independently hydrogen or lower alkyl having from about 1 to about 6 carbon atoms and each R1 and R2 is independently selected in each —O—CHR1-CHR2-unit; A is amino, N-alkyl amino having about 1 to about 20 carbon atoms in the alkyl group, N,N-dialkyl amino having about 1 to about 20 carbon atoms in each alkyl group, or a polyamine moiety having about 2 to about 12 amine nitrogen atoms and about 2 to about 40 carbon atoms; x is an integer from about 5 to about 100; and y is 0 or 1. In the formula, above, R is suitably a hydrocarbyl group having from about 1 to about 30 carbon atoms. Preferably, R is an alkyl or alkylphenyl group. More preferably, R is an alkylphenyl group, wherein the alkyl moiety is a straight or branched chain alkyl of from about 1 to about 24 carbon atoms.

Preferably, one of R1 and R2 is lower alkyl of 1 to 4 carbon atoms, and the other is hydrogen. More preferably, one of R1 and R2 is methyl or ethyl, and the other is hydrogen.

In general, A is amino, N-alkyl amino having from about 1 to about 20 carbon atoms in the alkyl group, preferably about 1 to about 6 carbon atoms, more preferably about 1 to about 4 carbon atoms; N,N-dialkyl amino having from about 1 to about 20 carbon atoms in each alkyl group, preferably about 1 to about 6 carbon atoms, more preferably about 1 to about 4 carbon atoms; or a polyamine moiety having from about 2 to about 12 amine nitrogen atoms and from about 2 to about 40 carbon atoms, preferably about 2 to 12 amine nitrogen atoms and about 2 to 24 carbon atoms. More preferably, A is amino or a polyamine moiety derived from a polyalkylene polyamine, including alkylene diamine. Most preferably, A is amino or a polyamine moiety derived from ethylene diamine or diethylene triamine.

Preferably, x is an integer from about 5 to about 50, more preferably from about 8 to about 30, and most preferably from about 10 to about 25.

The polyetheramines will generally have a molecular weight in the range from about 600 to about 10,000.

Fuel-soluble salts of the compounds of formula I can be readily prepared for those compounds containing an amino or substituted amino group and such salts are contemplated to be useful for preventing or controlling engine deposits. Suitable salts include, for example, those obtained by protonating the amino moiety with a strong organic acid, such as an alkyl- or arylsulfonic acid. Preferred salts are derived from toluenesulfonic acid and methanesulfonic acid.

Other suitable polyetheramines are those taught in U.S. Pat. No. 5,089,029 and U.S. Pat. No. 5,112,364.

c) Hydrocarbyl-Substituted Amines

Hydrocarbyl-substituted amines suitable for use in the present invention are well known to those skilled in the art and are described in a number of patents. Among these are U.S. Pat. Nos. 3,275,554; 3,438,757; 3,454,555; 3,565,804; 3,755,433 and 3,822,209. These patents describe suitable hydrocarbyl amines for use in the present invention including their method of preparation.

d) Nitrogen-Containing Condensates of Phenols, Aldehydes, and Amino Compounds

Phenol/aldehyde/amine condensates useful as AFMs in the present invention include those generically referred to as Mannich condensates. Such compounds can be made by reacting simultaneously or sequentially at least one active hydrogen compound for example a hydrocarbon-substituted phenol (e.g., an alkyl phenol wherein the alkyl group has at least an average of about 8 to 200; preferably at least 12 up to about 200 carbon atoms), having at least one hydrogen atom bonded to an aromatic carbon, with at least one aldehyde or aldehyde-producing material (typically formaldehyde or a precursor thereof) and at least one amino or polyamino compound having at least one NH group. The amino compounds include primary or secondary monoamines having hydrocarbon substituents of 1 to 30 carbon atoms or hydroxyl-substituted hydrocarbon substituents of 1 to about 30 carbon atoms. Another type of typical amino compound are the polyamines described above in relation to acylated nitrogen-containing compounds.

One class of preferred nitrogen containing detergent for use as an AFM in the present invention are those formed by a Mannich reaction between:

(a) an aldehyde;
(b) a polyamine; and
(c) an optionally substituted phenol.

Any aldehyde may be used as aldehyde component (a) but preferred are aliphatic aldehydes. Preferably the aldehyde has 1 to 10 carbon atoms, preferably 1 to 6 carbon atoms, more preferably 1 to 3 carbon atoms. Most preferably the aldehyde is formaldehyde.

Polyamine component (b) may be selected from any compound including two or more amine groups. Preferably the polyamine is a polyalkylene polyamine. Suitable polyalkylene polyamines are as previously defined herein.

Preferably the polyamine has 1 to 15 nitrogen atoms, preferably 1 to 10 nitrogen atoms, more preferably 3 to 8 nitrogen atoms.

Preferably the polyamine is selected from ethylenediamine, diethylenetriamine, triethylenetetramine, tetraethylenepentamine, pentaethylenehexamine, hexaethyleneheptamine, and heptaethyleneoctamine. Most preferably it is tetraethylenepentamine or ethylene diamine.

Commercially available sources of polyamines typically contain mixtures of isomers and/or oligomers, and products prepared from these commercially available mixtures fall within the scope of the present invention.

Optionally substituted phenol component (c) may be substituted with 0 to 4 groups on the aromatic ring (in addition to the phenol OH). For example it may be a tri- or di-substituted phenol. Most preferably component (c) is a mono-substituted phenol. Substitution may be at the ortho, and/or meta, and/or para position(s).

Preferably the phenol component (c) carries one or more optionally substituted alkyl substituents. Preferably the component (c) is a monoalkyl phenol, especially a para-substituted monoalkyl phenol.

In some preferred embodiments component (c) comprises an alkyl substituted phenol in which the phenol carries one or more alkyl chains having a total of less than 28 carbon atoms, preferably less than 24 carbon atoms, preferably less than 20 carbon atoms, more preferably less than 18 carbon atoms, preferably less than 16 carbon atoms and most preferably less than 14 carbon atoms.

For example component (c) may have alkyl substituents having from 4 to 20 carbons atoms, preferably 6 to 18, more preferably 8 to 16, especially 10 to 14 carbon atoms. In some particularly preferred embodiments, component (c) is a phenol having a C12 alkyl substituent.

In other preferred embodiments component (c) is substituted with a larger alkyl chain, for example those having in excess of 20 carbon atoms. Particularly preferred compounds are those in which the phenol is substituted with a hydrocarbyl residue made from homo or interpolymers (e.g. copolymers, terpolymers) of mono- and di-olefins having 2 to 10 carbon atoms, for example ethylene, propylene, butane-1, isobutene, butadiene, isoprene, 1-hexene, 1-octene, etc. Preferably these olefins are 1-monoolefins. The hydrocarbyl substituent may also be derived from the halogenated (e.g. chlorinated or brominated) analogs of such homo- or interpolymers. Alternatively the substituent may be made from other sources which are well known to those skilled in the art.

Especially preferred are phenols substituted with a polyisobutene residue of molecular weight of between 250 and 5000, for example between 500 and 1500, preferably between 650 and 1200, most preferably between 700 and 1000.

Suitable compounds include the reaction product obtained by reacting components (a), (b) and (c) in a ratio of from 5:1:5 to 0.1:1:0.1, more preferably from 3:1:3 to 0.5:1:0.5.

Components (a) and (b) are preferably reacted in a ratio of from 4:1 to 1:1 (aldehyde:polyamine), preferably from 2:1 to 1:1. Components (a) and (c) are preferably reacted in a ratio of from 4:1 to 1:1 (aldehyde:phenol), more preferably from 2:1 to 1:1.

Especially preferred compounds d) are those formed by reacting components (a), (b) and (c) in a ratio of 1:1:1 or 2:1:2. Mixtures of these compounds may also be used. Typically component (b) comprises a mixture of isomers and/or oligomers. Component (c) may also comprise a mixture of isomers and/or homologues.

e) Aromatic Esters of a Polyalkylphenoxyalkanol

The aromatic ester component which may be employed additive composition is an aromatic ester of a polyalkylphenoxyalkanol and has the following general formula:

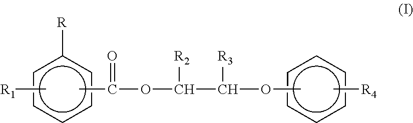

or a fuel-soluble salt thereof wherein R is hydroxy, nitro or —(CH₂)x-NR5R6, wherein
R5 and R6 are independently hydrogen or lower alkyl having 1 to 6 carbon atoms and
x is 0 or 1;
R1 is hydrogen, hydroxy, nitro or —NR7R8 wherein R7 and R8 are independently hydrogen or lower alkyl having 1 to 6 carbon atoms;
R2 and R3 are independently hydrogen or lower alkyl having 1 to 6 carbon atoms; and
R4 is a polyalkyl group having an average molecular weight in the range of about 450 to 5,000.

The preferred aromatic ester compounds employed in the present invention are those wherein R is nitro, amino, N-alkylamino, or —CH2NH2 (aminomethyl). More preferably, R is a nitro, amino or —CH2NH2 group. Most preferably, R is an amino or —CH2NH2 group, especially amino. Preferably, R1 is hydrogen, hydroxy, nitro or amino. More preferably, R1 is hydrogen or hydroxy. Most preferably, R1 is hydrogen. Preferably, R4 is a polyalkyl group having an average molecular weight in the range of about 500 to 3,000, more preferably about 700 to 3,000, and most preferably about 900 to 2,500. Preferably, the compound has a combination of preferred substituents.

Preferably, one of R2 and R3 is hydrogen or lower alkyl of 1 to 4 carbon atoms, and the other is hydrogen. More preferably, one of R2 and R3 is hydrogen, methyl or ethyl, and the other is hydrogen. Most preferably, R2 is hydrogen, methyl or ethyl, and R3 is hydrogen.

When R and/or R1 is an N-alkylamino group, the alkyl group of the N-alkylamino moiety preferably contains 1 to 4 carbon atoms. More preferably, the N-alkylamino is N-methylamino or N-ethylamino.

Similarly, when R and/or R1 is an N,N-dialkylamino group, each alkyl group of the N,N-dialkylamino moiety preferably contains 1 to 4 carbon atoms. More preferably, each alkyl group is either methyl or ethyl. For example, particularly preferred N,N-dialkylamino groups are N,N-dimethylamino, N-ethyl-N-methylamino and N,N-diethylamino groups.

A further preferred group of compounds are those wherein R is amino, nitro, or —CH2NH2 and R1 is hydrogen or hydroxy. A particularly preferred group of compounds are those wherein R is amino, R1, R2 and R3 are hydrogen, and R4 is a polyalkyl group derived from polyisobutene.

It is preferred that the R substituent is located at the meta or, more preferably, the para position of the benzoic acid moiety, i.e., para or meta relative to the carbonyloxy group. When R1 is a substituent other than hydrogen, it is particularly preferred that this R1 group be in a meta or para position relative to the carbonyloxy group and in an ortho position relative to the R substituent. Further, in general, when R1 is other than hydrogen, it is preferred that one of R or R1 is located para to the carbonyloxy group and the other is located meta to the carbonyloxy group. Similarly, it is preferred that the R4 substituent on the other phenyl ring is located para or meta, more preferably para, relative to the ether linking group.

The aromatic esters e) will generally have a molecular weight in the range from about 700 to about 3,500, preferably from about 700 to about 2,500.

Fuel-soluble salts of the compounds e) can be readily prepared for those compounds containing an amino or substituted amino group and such salts are contemplated to be useful for preventing or controlling engine deposits. Suitable salts include, for example, those obtained by protonating the amino moiety with a strong organic acid, such as an alkyl- or arylsulfonic acid. Preferred salts are derived from toluenesulfonic acid and methanesulfonic acid.

When the R or R1 substituent is a hydroxy group, suitable salts can be obtained by deprotonation of the hydroxy group with a base. Such salts include salts of alkali metals, alkaline earth metals, ammonium and substituted ammonium salts. Preferred salts of hydroxy-substituted compounds include alkali metal, alkaline earth metal and substituted ammonium salts.

A fatty acid and/or amine derivative of a fatty acid is an essential element in the use of the invention, whilst an AFM is not, but may often be a preferred element in obtaining excellent performance. When an AFM is present the weight ratio of a) a fatty acid and/or amine derivative of a fatty acid (total weight when more than one such is present) and b) an AFM (total weight when more than one such is present) is in the proportion 1 to 10000 parts a) to 100 parts b), preferably 10 to 1000 parts a) to 100 parts b), preferably 30 to 500 parts a) to 100 parts b), preferably 50 to 3000 parts a) to 100 parts b).

The amount of the fuel additive of the invention, namely a fatty acid and/or amine derivative of a fatty acid, and an AFM when an AFM is present (total amounts of each class) is preferably up to 10,000 ppm in the fuel, preferably up to 1,000 ppm, preferably from 1 to 500 ppm, preferably 10 to 200 ppm, and preferably 15 to 100 ppm.

An important additive which may present in certain preferred embodiments is a dispersant or detergent. This is preferably a nitrogen containing compound. This may suitably be present in the fuel at a treat rate in the range 0.1 to 250 ppm, preferably 1 to 100 ppm (total amount when more then one is present). Some of the AFMs mentioned above also have dispersant properties, namely:
Polyethers
Polyetheramines
Reaction products of acylating agents and amines, for example poly(isobutenylsuccinimides) (PIBSIs)
Polyalkylene amines
Mannich bases based on tertiary alky substituted phenol and C1-20 primary amines or polyalkylene amines
Mixtures containing any of these.

When a compound is a dispersant and an AFM herein, it may count as part of the defined complement of each.

The invention will now be further described with reference to the following examples. Reference or comparative examples are denoted by the prefix “C”.

### EXAMPLES

### Example 1

### Preparation of an Amide from Ethylene Diamine and Tall Oil Fatty Acids (TOFA)

TOFA (20 g 0.07 mol) was dissolved in toluene (50 ml) in a round bottom flask fitted with a Dean and Stark attachment. Ethylene diamine (4.2 g 0.07 M) added to the flask and the reaction mixture stirred under nitrogen and refluxed at 115° C. for 5 hours. The solvent was then removed under vacuum to afford the amide product.

### Examples 2-11

Further amides were prepared by reacting fatty acids and amines in a 1:1 mol ratio using a similar method to that of Example 1, as shown in Table 1.

TABLE 1

| Example | Fatty Acid | Amine |
|---|---|---|
| 1 | TOFA | Ethylene diamine (EDA) |
| 2 | TOFA | Diethylene triamine (DETA) |
| 3 | TOFA | Triethylene tetramine (TETA) |
| 4 | TOFA | Tetraethylene pentamine (TEPA) |
| 5 | TOFA | Ethanolamine |
| 6 | Oleic Acid | Pentaethylene hexamine (PEHA) |
| 7 | Oleic Acid | Ethanolamine |
| 8 | Oleic Acid | Diethanolamine |
| 9 | Oleic Acid | N,N,N trimethylethylenediamine |
| 10 | Oleic Acid | Triethylene tetramine (TETA) |
| 11 | TOFA | n-Butylamine |

### Comparative Example C12

Example C12 is a commercially available product which is believed to be a fatty acid ester, namely pentaerythritol monooleate.

Screening Method for Examples 1-11 and C12

In this Example Set the TE77 reciprocating sliding test was used. This employed a Cameron-Plint TE77 High Frequency Reciprocating Tribometer. The piston stroke was set at ±12.4 mm, and the frequency at 25 Hz.

The TE77 Tribometer was fitted with a section of Ford F6173038 liner and a section of the corresponding Ford F6165200 compression piston ring.

The liner sample was situated in the sample bath fixed on a heated bed to enable the temperature of the sample to be adjusted according to demand.

The sample bath was filled with 10 mls of pure XHVI 4.0 (unadditised lubricant base stock) oil.

Before each experiment the machine was run for a period of time at a reduce load (10N) to ensure the system had achieved thermal equilibrium before testing began. Once thermal equilibrium was achieved, the load was increased to 75N and run for 40 minutes to establish a baseline. The data acquisition sampling occurred every second throughout the test.

After approximately 40 minutes had passed, 0.1 mls of oil containing 100000 ppm (10% active) additive was added to the oil, providing the test oil with 1000 ppm of the active.

Following the addition of the additive the test continued to run for a further 50 minutes.

At 30 minutes (prior to the additive addition) the friction force was logged at 50,000 Hz.

At 75 minutes (after 35 minutes post the addition of the additive) the friction force was logged at 50,000 Hz.

From this the maximum range (minimum to maximum) was calculated for each set of data.

From this the percentage reduction with the use of the additive was determined.

From the data acquired an average for the Coefficient of Friction (μ) prior to the introduction of the additive was determined by taking the averages of the values recorded between 26 to 39 minutes.

The percentage change in Coefficient of Friction (μ) was calculated from the acquired Coefficient of Friction (μ) against the average of the Coefficient of Friction (μ) prior to the introduction of the additive.

A temperature of 125° C. and a load of 75 N was chosen to screen the compounds. The additives were ranked for performance in terms of the percentage change in Coefficient of Friction.

Results—Friction Force and Friction Co-Efficient

| | | | | Reduction |
|---|---|---|---|---|
| | | | Reduction | in Friction |
| Exam- | | | in | Coefficient, |
| ple | Fatty Acid | Amine | Force, % | % |
| 1 | TOFA | Ethylene diamine (EDA) | 44.6 | 50 |
| 2 | TOFA | Diethylene triamine | 28.9 | 40 |
| | | (DETA) | | |
| 3 | TOFA | Triethylene tetramine | 25.0 | 30 |
| | | (TETA) | | |
| 4 | TOFA | Tetraethylene pentamine | 34.3 | 40 |
| | | (TEPA) | | |
| 5 | TOFA | Ethanolamine | 23.6 | 30 |
| 6 | Oleic Acid | Pentaethylene hexamine | 28.0 | 40 |
| | | (PEHA) | | |
| 7 | Oleic Acid | Ethanolamine | 25.0 | 20 |
| 8 | Oleic Acid | Diethanolamine | 22.7 | 20 |
| 9 | Oleic Acid | N,N,N | 20.4 | 15 |
| | | trimethylethylenediamine | | |
| 10 | Oleic Acid | Triethylene tetramine | 37.7 | 50 |
| | | (TETA) | | |
| 11 | TOFA | n-Butylamine | 17.6 | 30 |

| | | | |
|---|---|---|---|
| C12 | Comparative - Pentaerythritol | 16.3 | 10 |
| | mono oleate | | |

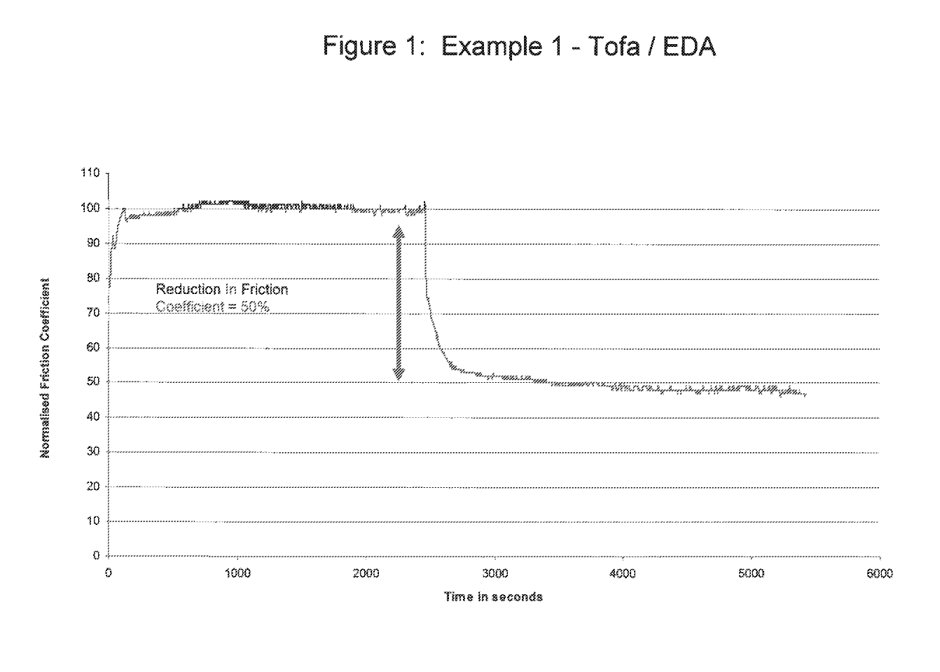

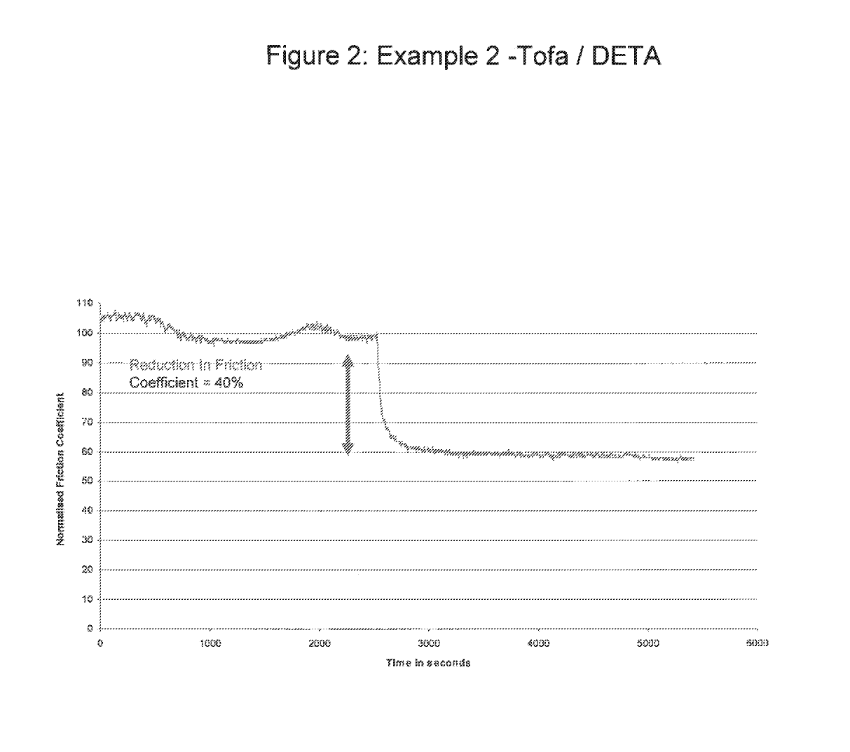

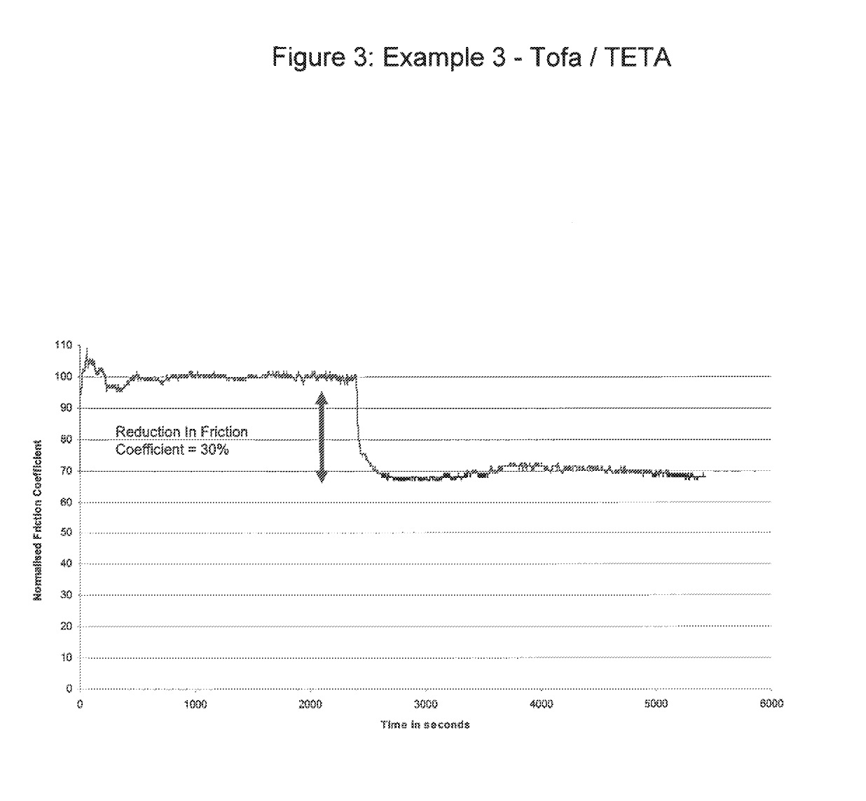

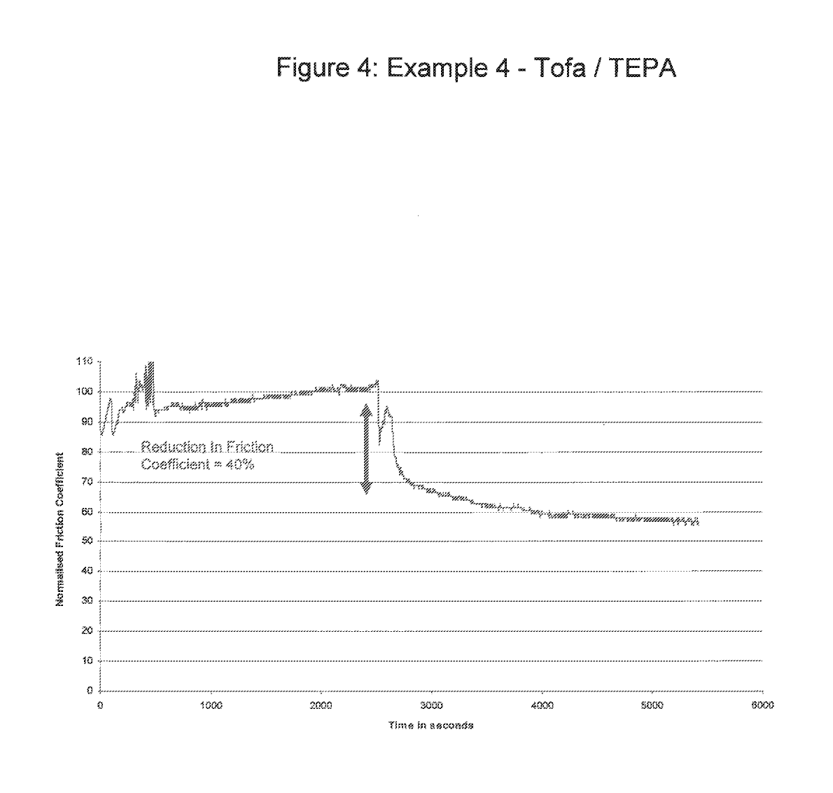

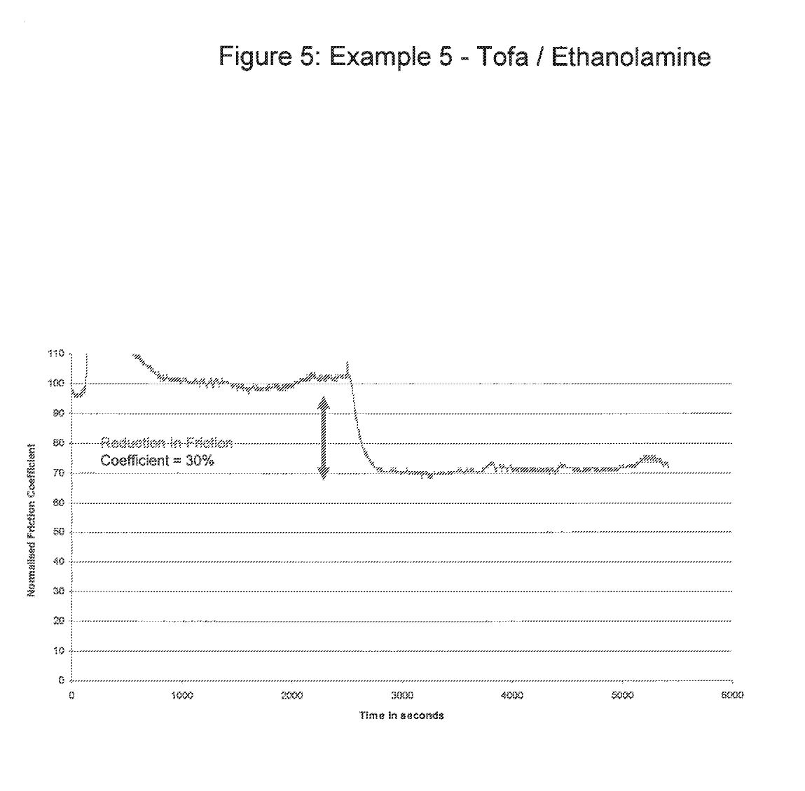

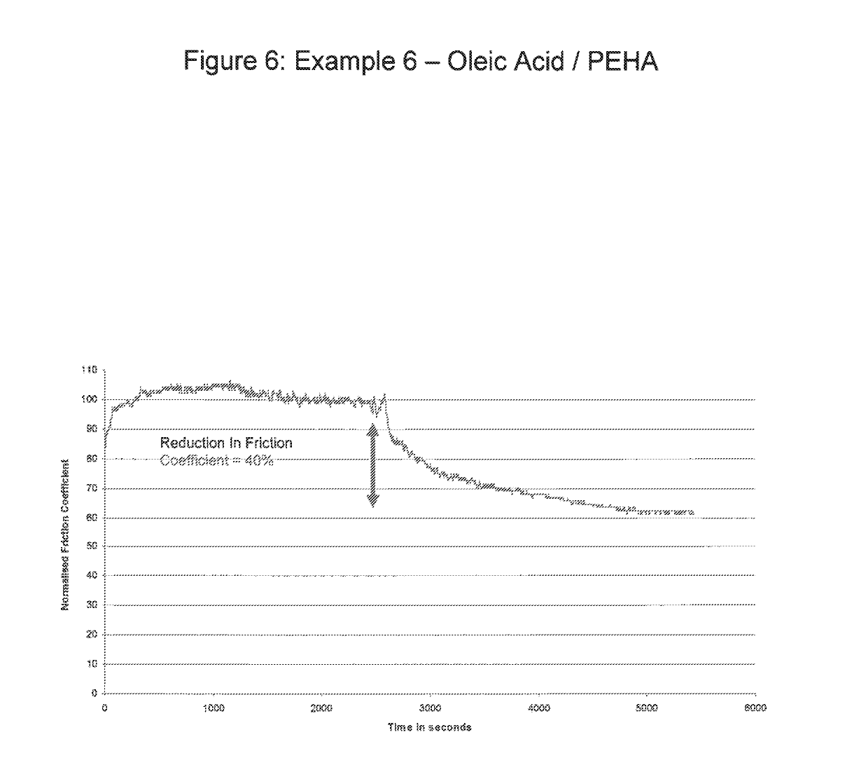

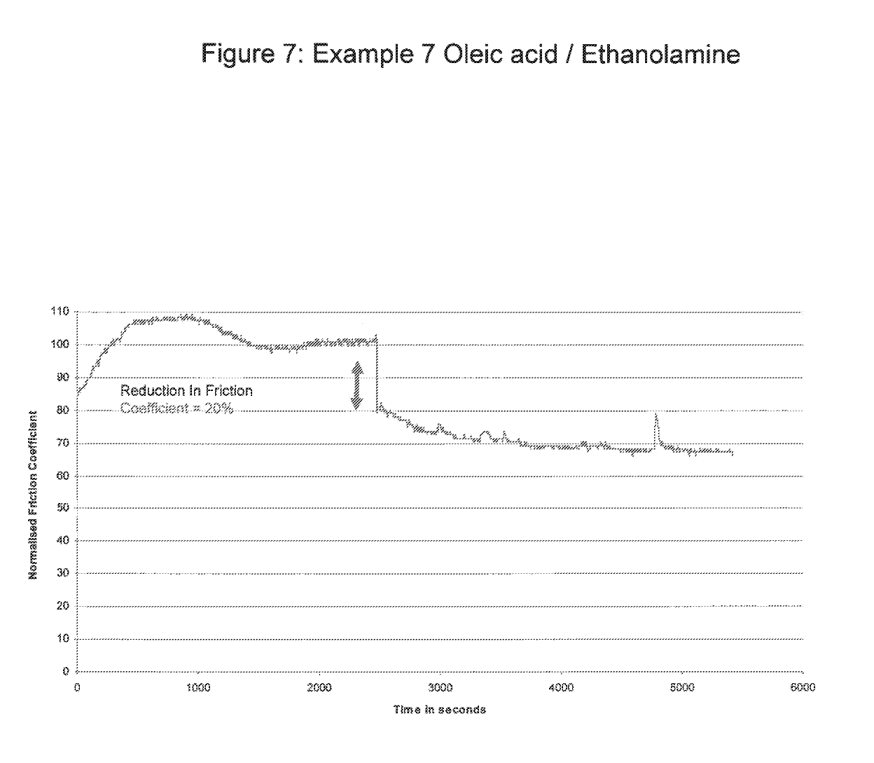

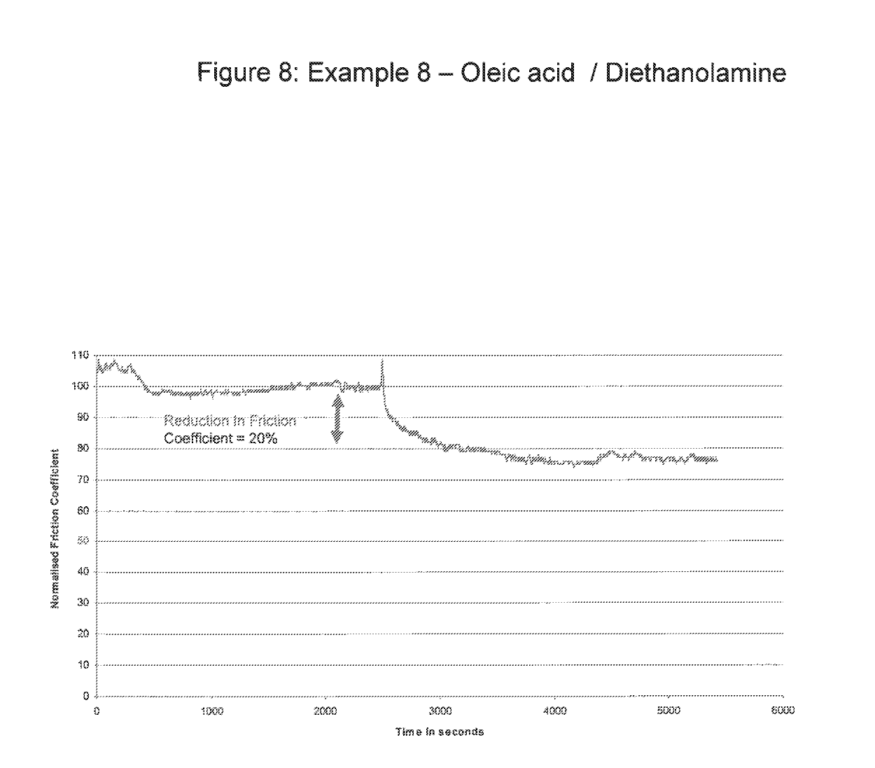

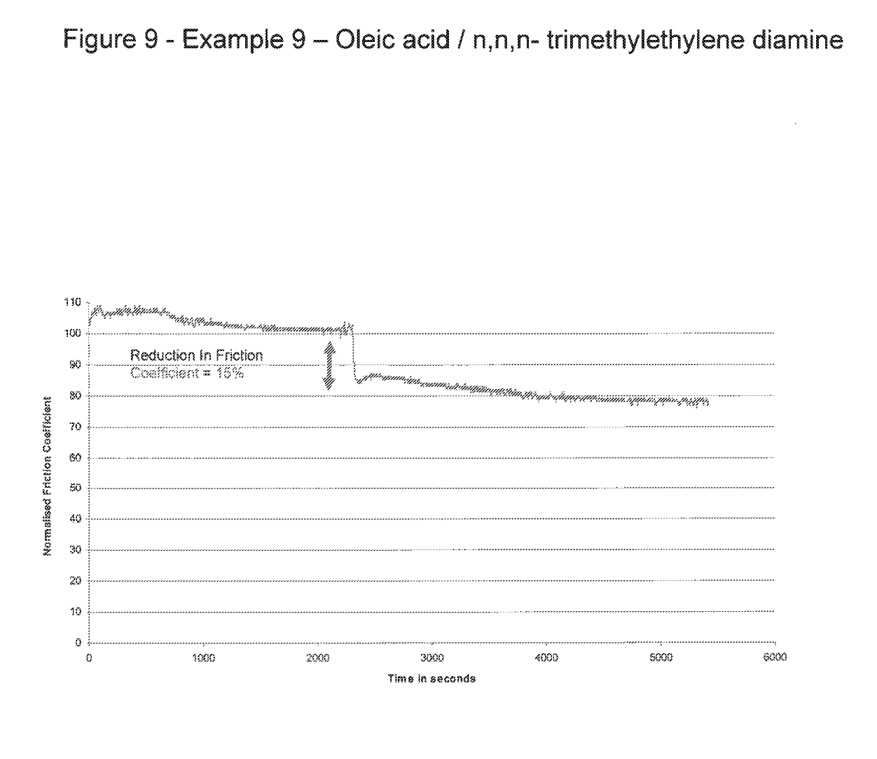

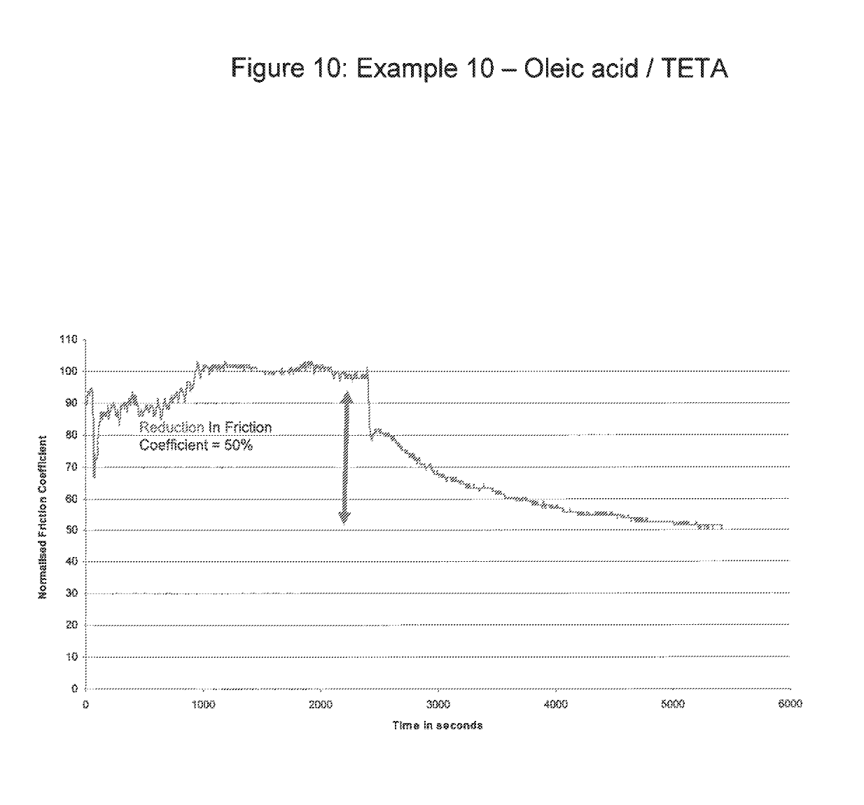

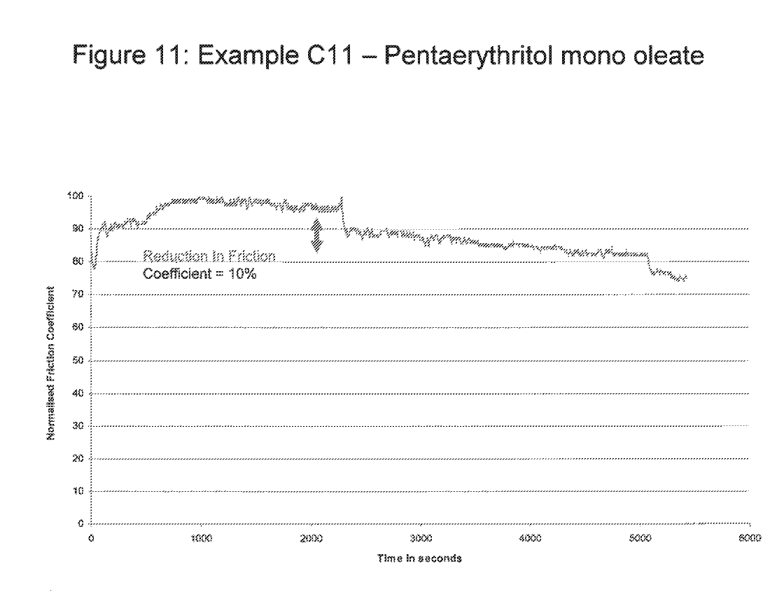

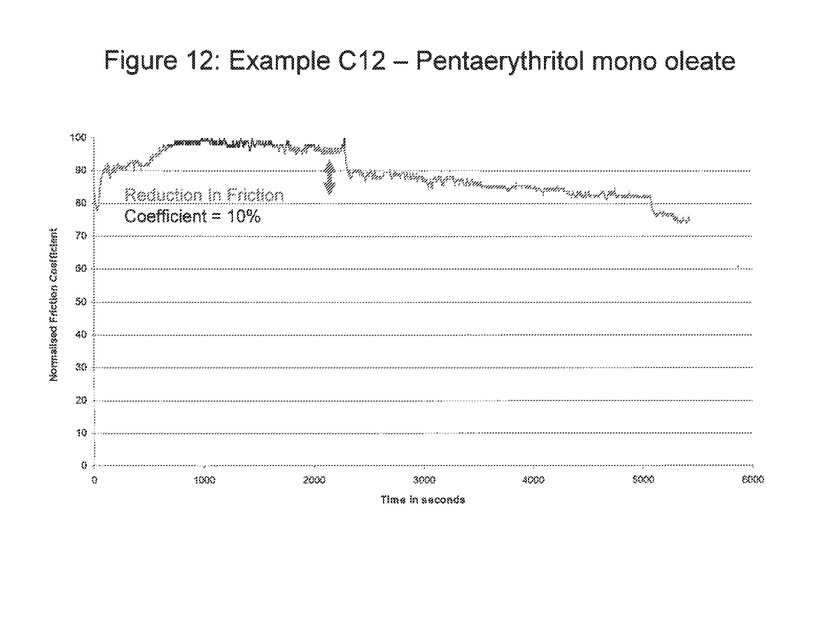

FIGS. 1-12 show the change in the Coefficient of Friction due to additive Examples 1-11 and C12 as a function of time.

### Examples C13, C14, 15 and 16

### HFRR Testing

Four additive compositions were tested by the standard HFRR method (test method CEC F-06-A-96) and their wear scars measured. This is a widely-accepted test for the assessment of the lubricity of a fuel. The additive compositions were added at a treat rate of 200 mg/l (amount of active) in a standard low sulphur reference diesel fuel.

Example C13 is the Ciba (BASF) product IRGALUBE F10A, is believe to be a fatty acid ester, namely a mixed ester of glycerol, dodecanoic acid and a hindered phenol substituted propanoic acid.

Example C14 is a commercially available product which is believed to be a fatty acid ester, namely pentaerythritol monooleate.

Example 15 is 95 wt % tall oil fatty acid, 2.5 wt % phenolic antioxidant and 2.5 wt % solvent. The use of this additive is in accordance with the present invention.

Example 16 is an amide formed by reaction between tall oil fatty acid and ethylene diamine, in equimolar amounts. The use of this additive is in accordance with the present invention.

Wear scar values are set out below.

| | Reduction in | | Reduction in |
|---|---|---|---|
| | WSD | Increase in Film | Friction Coefficient |
| Additive | (%) | Thickness | μ (%) |
| Example C13 | 21.6 | −10.0 | 35.6 |
| Example C14 | 48.0 | 295.0 | 60.5 |
| Example 15 | 47.1 | 275.0 | 61.2 |
| Example 16 | 29.3 | 155.0 | 53.1 |

It will be observed that the results for Example 15 and Example 16 are broadly similar to the results for Example C13 and Example C14.

### Examples C13, C14, 15 and 16

### TE77 Testing

In this Example Set the TE77 reciprocating sliding test was used. This employed a Cameron-Plint TE77 High Frequency Reciprocating Tribometer. The piston stroke was set at ±5 mm, and the frequency at 33.3 Hz (equivalent to a speed of 2000 rev/min).

The TE77 Tribometer was fitted with a section of Jaguar cylinder liner whose bore gave good conformity with a non-compressed Ricardo Hydra compression piston ring. The liner sample sat on a heated bed to enable the temperature of the sample to be adjusted according to demand.

The oil feed system consisted of a direct drip feed onto the liner specimen to simulate the relatively starved lubrication conditions in the simulated area of the engine.

The system consisted of two sumps. The first sump contained clay filtered diesel, blended with pure XHVI 8.2 (unadditised lubricant base stock) oil in the proportion 30:70. The second sump contained diesel containing the additive being tested, blended with pure XHVI 8.2 also in the proportions 30:70.

Before each experiment the machine was run for a period of time to ensure the system had achieved thermal equilibrium before testing began.

Once equilibrium was achieved, the machine was run on pure diesel in oil for 1 hour to establish a baseline. During this time data acquisition sample occurred every 10 minutes.

After one hour had passed, the sumps were manually switched over to the system running on diesel with additive in oil. For the first 10 minutes sampling occurred every minute following which sampling occurred every 10 minutes for a further 50 minutes.

Once the machine had run on the additive for a total of one hour, the sump was switched back to pure diesel and oil. Sampling occurred every minute for 10 minutes, then sampling occurred every 5 minutes for the final 20 minutes of the test.

At 40 minutes (after 40 minutes running on pure diesel oil) the friction force was logged at 10,000 Hz.

At 90 minutes (after 30 minutes running on pure diesel oil) the friction force was logged at 10,000 Hz.

From this the maximum range (minimum to maximum) is calculated for each set of data.

From this the percentage reduction with the use of the additive is determined.

For the pure diesel fuel in oil the Coefficient of Friction (μ) was determined by taking the averages of the values recorded from 30 to 50 minutes (centred around 40 minutes to correspond to the friction force measurements).

For the additised diesel fuel in oil the Coefficient of Friction was determined by taking the average of the values recorded from 80 to 100 minutes (centred around 90 minutes to correspond to the friction force measurements).

The reduction in Coefficient of Friction was determined from the difference in these two values.

A temperature of 125° C. and a load of 100 N was chosen to screen the compounds. The additives were ranked for performance in terms of the reduction in average Coefficient of Friction and the reduction in peak to peak friction force.

The former is believed to be indicative of mixed lubrication performance whereas the latter is believed to be indicative of pure boundary lubrication.

Results—Friction Force and Friction Coefficient (μ)

| | Reduction in | Reduction in μ |
|---|---|---|
| Additive | Force | (%) |
| Example C13 | −9.8 | −6.3 |
| Example C14 | 9.8 | 1.9 |
| Example 15 | 17.3 | 15.0 |
| Example 16 | 43.1 | 31.5 |

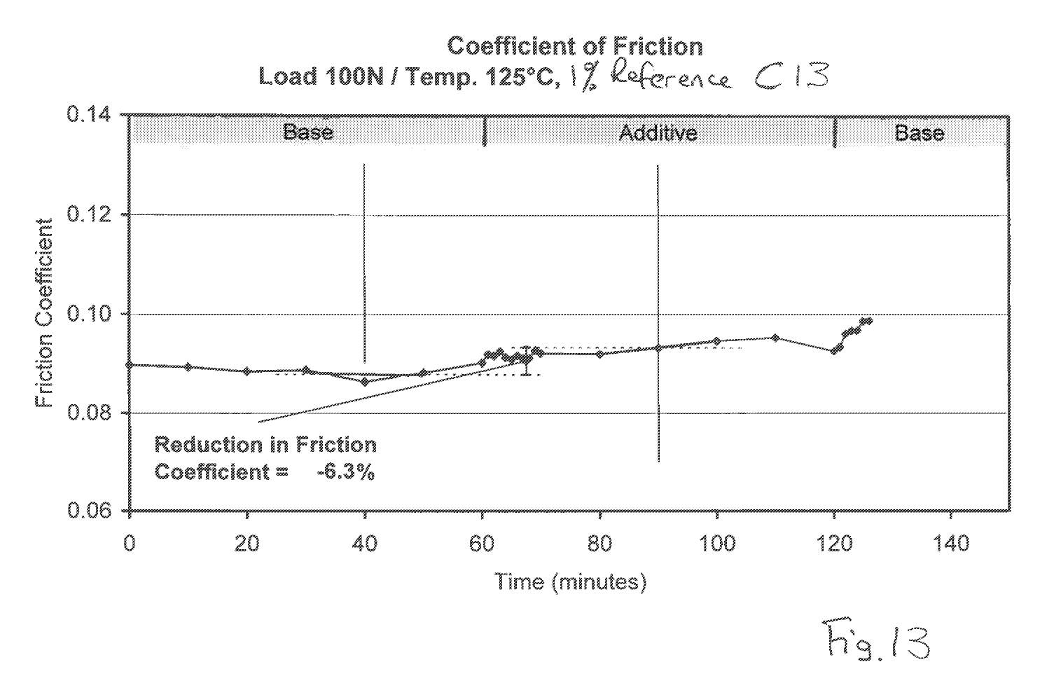

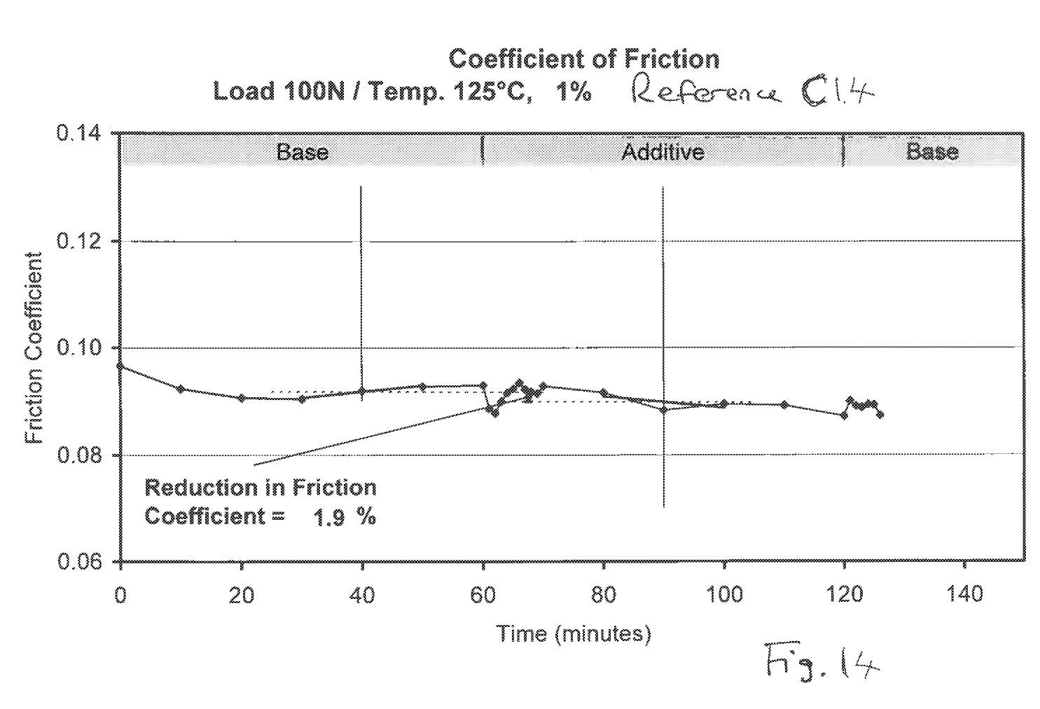

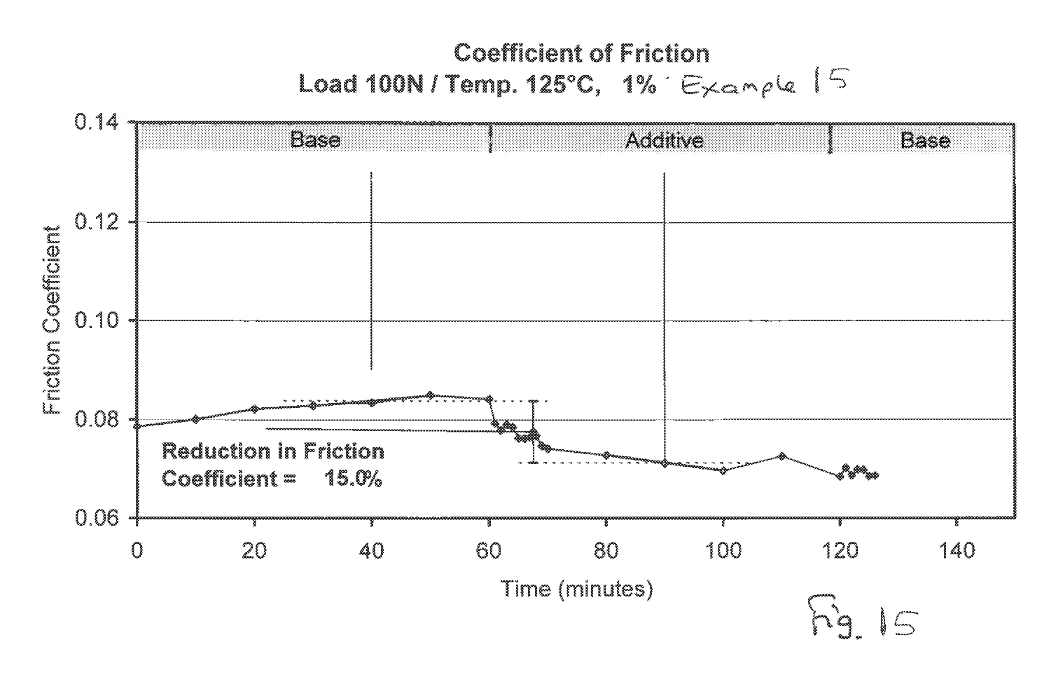

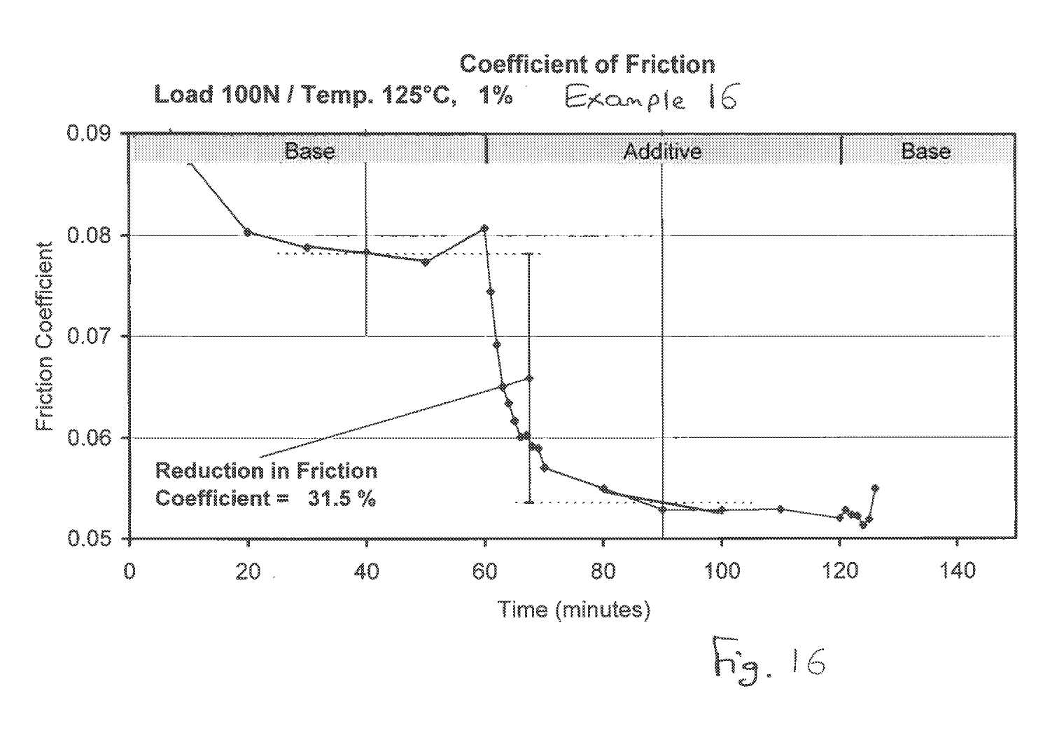

FIG. 13 shows the change in the Coefficient of Friction due to additive Example C13 as a function of time; FIG. 14 shows the change in the Coefficient of Friction due to additive Example C14 as a function of time; FIG. 15 shows the change in the Coefficient of Friction due to additive Example 15 as a function of time; and FIG. 16 shows the change in the Coefficient of Friction due to additive Example 16 as a function of time.

The small benefits achieved by Example C13 and Example C14 stand in contrast to the larger benefit achieved by Example 15, and in particular the very large benefit achieved by Example 16. It also stands in contrast to the HFRR testing of Example C13 and Example C14, which did not suggest any significant differentiation between Examples C13 and C14, and Examples 15 and 16. It will be seen that Example 15 and, especially, Example 16, gives large, instantaneous benefit when added and that substantially full benefit is achieved quickly. This instantaneous benefit is a preferred feature of some embodiments of the present invention.

1. A method of increasing the efficiency of an engine combusting a fuel, the method comprising combusting in the engine a diesel fuel composition comprising an additive, wherein the additive comprises a fatty acid, a derivative of a fatty acid and an amine, or combinations thereof.

2. The method of claim 1, wherein the method further comprises reducing the losses arising from the sliding of the pistons of an engine within their cylinders.

3. The method of claim 1, wherein the method further comprises improving the fuel economy of an engine combusting the fuel.

4. The method of claim 1, wherein the derivative of a fatty acid and an amine is a fatty acid amide.

5. The method of claim 1, wherein the derivative of a fatty acid and an amine is a salt of a fatty acid and an amine.

6. The method of claim 1, wherein the fatty acid is represented by the formula:
R(COOH)ₙ
wherein R represents a hydrocarbyl group having 2 to 50 carbon atoms, and n represents an integer of 1 to 4.

7. The method of claim 6 wherein the fatty acid is a monocarboxylic acid having from 8 to 30 carbon atoms.

8. The method of claim 7 wherein the fatty acid is tall oil fatty acid.

9. The method of claim 1, wherein the amine is an aliphatic amine having a hydrocarbyl group of 2 to 50 carbon atoms and 1 to 10 nitrogen atoms.

10. The method of claim 1, wherein a treat rate of the fatty acid is in the range from 15 to 10,000 ppm in the fuel.

11. The method of claim 1, wherein the fuel further contains an additional friction modifier (AFM) selected from one or more of:
esters of fatty acids,
aliphatic amines,
aliphatic esters,
aromatic esters,
aliphatic ethers,
polyethers,
polyetheramines,
polyhydric aliphatic alcohols,
hydrocarbyl succinic acids and derivatives,
reaction products of acylating agents and amines,
N,N-bis(hydroxyalkyl)-alkylamine,
hydroxyl containing esters of mono carboxylic acid and polyols,
alkylalkoxy amides,
polyalkylene amines,
mannich bases based on tertiary alky substituted phenol and C1-20 primary amines or polyalkylene amines,
polyisobutylene amines,
mixtures of esters and polyisobutylene amines, and
mixtures of esters and polyetheramines.

12. The method of claim 11, wherein a weight ratio of a) the fatty acid and b) the AFM is in the proportion 1 to 10000 parts a) to 100 parts b).

13. The method of claim 11, wherein the reaction products of acylating agents and amines is poly(isobutenylsuccinimides) (PIBSIs).
